(19) United States
(12) Patent Application Publication
(10) Pub. No.: US 2012/0160339 A1
(43) Pub. Date: Jun. 28, 2012

(54) SELF-SEALING VALVE

(75) Inventors: José MERINO LOPEZ, Clermont-Ferrand (FR); Michel AHOUANTO, Enval (FR); Lucien SILVAIN, Clermont-Ferrand (FR); Loïc ALBERT, Clermont-Ferrand (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/336,076

(22) Filed: Dec. 23, 2011

(30) Foreign Application Priority Data
Dec. 27, 2010 (FR) 1061283

(51) Int. Cl. F16K 15/20; C08L 25/06

(52) U.S. Cl. 137/223; 524/577

(57) ABSTRACT

A self-sealing valve for a tyre includes at least a part formed of a self-sealing material having a dynamic shear modulus G*, measured at 10 Hz, less than or equal to 0.06 MPa, preferably less than or equal to 0.03 MPa, and more preferably still, less than or equal to 0.01 MPa.

### CROSS-REFERENCE TO RELATED APPLICATION

The present application claims the benefit of priority of Application No. 1061283 filed in France on Dec. 27, 2010, the entire disclosure of which is incorporated by reference herein.

### FIELD OF THE INVENTION

The present invention relates generally to a self-sealing valve, and aspects of the present invention relate to a valve formed of, at least in part, a low elastic modulus material. Embodiments of the invention may apply to an object intended to contain air under pressure, such as a wheel rim, an inner tube, or a tyre, for example. In the case of a tyre or a rim, the embodiments may apply to any type of tyre or rim, notably those intended to be fitted to passenger type vehicles, SUVs (Sport Utility Vehicles), two-wheels vehicles (notably motorbikes), aeroplanes, industrial vehicles chosen from pick-ups, heavy vehicles—which means subway, buses, heavy road transport vehicles (lorries, tractors, trailers), off-road vehicles such as agricultural or civil engineering machinery—or other transport or handling vehicles.

### BACKGROUND

The prior art discloses a tyre of the tubeless type, which is one that has no inner tube inner tube. Such a tyre is intended to be mounted on a rim provided with an orifice in which a mechanical valve is housed. Such a valve is described in document WO 2004/002760.

However, such a valve, in addition to being relatively complicated, presents a level of tightness that can be improved upon.

### SUMMARY OF THE INVENTION

It is an object of an embodiment of the invention to provide a valve that is simpler and more effective.

To this end, one subject of the invention is a self-sealing valve for a tyre, for a rim, or for an inner tube, characterized in that the valve includes a self-sealing material containing at least one elastomer that has a dynamic shear modulus G*, measured at 10 Hz, less than or equal to 0.06 MPa, preferably less than or equal to 0.03 MPa, and more preferably still, less than or equal to 0.01 MPa.

The valve according to an embodiment makes it possible to achieve good tightness because of the behaviour of the self-sealing material. Specifically, the material has an almost purely elastic mechanical behaviour which means that even after an air injection member, for example a needle, has passed through it, the tightness of the valve is assured by the material which comes to fill the passage made by the member, under the effect of the internal pressure of the tyre or of the inner tube.

Further, the valve according to an embodiment is relatively simple because the material alone is enough to seal the valve and therefore the tyre or the inner tube.

The valve according to an embodiment has the advantage of having, in a very wide range of service temperatures, an almost purely elastic mechanical behaviour. This behaviour substantially improves the speed of sealing when the valve is pierced by an air injection member, for example a needle.

The self-sealing material according to an embodiment exhibits a mechanical behaviour very close to that of an elastic material. This advantage is demonstrated during withdrawal of the air injection member. Because the material has an almost purely elastic behaviour, during the withdrawal, under the action of the hydrostatic compressive forces, the response of the material is near-instantaneous. No lack of tightness is observed.

It is also possible to characterize the self-sealing material via the fact that it has a dynamic extension modulus lower than 0.18 MPa, preferably lower than 0.09 MPa, and more preferably still, lower than 0.03 MPa. Remember that the extension modulus and the shear modulus are connected by the relationship E*=2(1+ν)·G* where ν is Poisson's ratio.

For preference, for any temperature in a given temperature range between −30° C. and +100° C., the self-sealing material has a loss factor tan δ (also known as “tg δ”) less than 0.2 and a dynamic modulus G* below 0.05 MPa, preferably below 0.03 MPa and more preferably still, below 0.01 MPa; tan δ and G* being measured at a frequency of 10 Hz. For preference, G* is lower than the inflation pressure Pg of the pressurized air in contact with the valve.

It is also noted that when the dynamic modulus G* becomes higher than the inflation pressure Pg in the given temperature range, the sealing properties of the self-sealing material are impaired. This is because since the driving force behind many of the sealing mechanisms is the compressive forces connected with the pressure to which the tyre is inflated, when the dynamic modulus G* of a self-sealing material is higher than or equal to the inflation pressure Pg, it is found that the self-sealing material is no longer deformable enough effectively to seal the hole left by the withdrawal of the air injection member. By contrast, certain self-sealing materials that are too rigid for tyres of passenger vehicles, the service pressure of which is between 2 and 3 bar, can be used successfully for heavy vehicle tyres which have a service pressure of the order of 8 to 10 bar.

The dynamic modulus G* is also preferably higher than Pg/30. That, combined with the very low loss factor, gives excellent stability of shape in high-speed and high-temperature running.

When the air injection member pierces the valve, the inflation pressure Pg places the self-sealing material in a state of hydrostatic compression and the lower its extension modulus or its dynamic shear modulus, the more perfect this state of hydrostatic compression is. These forces press the self-sealing material against the member and seal the valve. After the air injection member has been withdrawn, these same hydrostatic compressive forces keep the orifice left by the member in the valve closed and thus keep the valve tight.

The elastomer materials are dynamically characterized on an Anton Paar MCR 301 rheometer. The test specimens are cylindrical, 2.5 mm thick and 4 mm in diameter. The test specimens are placed in a heat chamber between two flat plates, one fixed and the other oscillating sinusoidally about its centre and a normal stress of 0.02 MPa is also applied throughout the duration of the tests. A maximum deformation of 1% is applied and the temperature is incremented from −100° C. to 250° C. at a rate of 5°/min. The results exploited are the dynamic shear modulus G* and the loss factor tan δ in the given temperature range.

G*=(G′²+G″²)^{1/2} and tan δ=G″/G′

G* is the dynamic shear modulus in MPa;

G′ is the true shear modulus in MPa;

G″ is the shear loss modulus in MPa; and

δ is the loss factor between the imposed deformation and the measured stress.

σ_{R} and ε_{R} are the stresses and elongations of the test specimens of material, measured at rupture (σ_{R} is with respect to the initial cross section So of the test specimen).

The commercially available products “Mediprene 500 000 M” and “Multiflex G00” are known to be self-sealing materials. These two materials have paraffin-based extension oil contents of the order of 400 pce or parts by weight per hundred parts elastomer. These materials have tan δ values lower than 0.15 throughout the [0° C. to 130° C.] temperature range. Their behaviour is thus practically purely elastic throughout this temperature range. These two materials have an elongation at break greater than 1000% and a rupture stress in excess of 0.2 MPa.

The dynamic shear modulus of these two materials ranges between 30000 and 60000 Pa in the same temperature range. These dynamic shear modulus values give them very high flexibility which is highly favourable for sealing mechanisms in passenger vehicles where the inflation pressure is of the order of 1 to 3 bar.

By way of comparison, a conventional butyl-elastomer-based material has a tan δ value always higher than 0.2 throughout the temperature range considered. It should be noted that the tan δ value of this butyl-elastomer-based material increases very sharply as soon as the temperature drops below 50° C., which means to say that the associated increase in dynamic shear modulus will impair the low-temperature sealing behaviour. It is a notable advantage of the materials according to embodiments of the invention that they have sealing behaviour that remains stable across a very wide range of temperatures, particularly at cold temperatures. At high temperature, the fact that the observed increases in the tan δ values are appreciable only beyond 100° C. is very positive in guaranteeing good dimensional stability of the self-sealing valve in the tyre, particularly in high-speed running.

For preference, the valve is pre-slit. The pre-slitting makes it possible to avoid the use of a pointed air injection member which could then present a danger to the user of the valve. Thus, it is possible to use an injection member than has a blunt end.

For preference, the valve is made of the self-sealing material.

As an option, the self-sealing material may contain a composition that includes at least, by way of predominant elastomer, a thermoplastic styrene elastomer and an extension oil in a proportion of between 200 and 700 parts by weight per hundred parts elastomer.

In the present description, unless expressly indicated otherwise, all the percentages (%) indicated are % by weight.

Thermoplastic Styrene Elastomer

Thermoplastic styrene elastomers (“TPS” for short) are thermoplastic elastomers that come in the form of styrene-based block copolymers.

Being, in terms of structure, somewhere between a thermoplastic polymer and an elastomer, they are, as is known, made up of rigid polystyrene sequences connected by flexible elastomer sequences, for example polybutadiene, polyisoprene or poly(ethylene/butylene). They are often three-block elastomers with two rigid segments connected by one flexible segment. The rigid and flexible segments can be arranged in a straight line, in a star, or in a branched configuration.

For preference, the TPS elastomer is chosen from the group consisting of styrene/butadiene/styrene (SBS), of styrene/isoprene/styrene (SIS), of styrene/isoprene/butadiene/styrene (SIBS), of styrene/ethylene/butylene/styrene (SEBS), of styrene/ethylene/propylene/styrene (SEPS), of styrene/ethylene/ethylene/propylene/styrene (SEEPS) block copolymers and mixtures of these copolymers.

More preferably still, the elastomer is chosen from the group consisting of SEBS copolymers, SEPS copolymers and mixtures of these copolymers.

According to another preferred embodiment of the invention, the proportion of styrene in the TPS elastomer is between 5 and 50%.

Below the indicated minimum, there is a risk that the thermoplastic nature of the elastomer will be significantly diminished whereas above the recommended maximum, the elasticity of the composition may be adversely affected. For these reasons, the proportion of styrene is more preferably between 10 and 40%, particularly between 15 and 35%.

It is preferable for the glass transition temperature (Tg, measured in accordance with ASTM D3418) of the TPS elastomer to be below −20° C., and more preferably still, below −40° C.

A Tg value higher than these minima would give the self-sealing compound itself a higher Tg, which could diminish the performance of the self-sealing composition when used at very low temperature; for such a use, the Tg of the TPS elastomer is more preferably still below −50° C.

The number-average molecular weight (denoted Mn) of the TPS elastomer is preferably between 50000 and 500000 g/mol, more preferably still, between 75000 and 450000. Below the indicated minima, there is a risk of the cohesion between the chains of TPS elastomer being adversely affected because it is diluted so much (quantity of extension agent); on the other hand, an increase in the service temperature carries the risk of adversely affecting the mechanical properties, notably the properties at rupture, thereby diminishing the “hot” performance. Furthermore, too high an Mn may impair the flexibility of the composition, for the recommended extension oil proportions. Thus, it has been found that a value in a range from 250000 to 400000 was particularly well suited.

The number-average molecular weight (Mn) of the TPS elastomer is determined in the known way, using steric exclusion chromatography (SEC). The test specimen is dissolved beforehand in tetrahydrofuran at a concentration of around 1 g/l; the solution is then filtered on a filter of porosity 0.45 μm before being injected. The equipment used is a “WATERS alliance” chromatography apparatus. The elution solvent is tetrahydrofuran, the flow rate 0.7 ml/min, the temperature of the system 35° C., and the duration of the analysis 90 min. Use is made of a set of four WATERS columns in series, with the trade names “STYRAGEL” (“HMW7”, “HMW6E” and two “HT6E”). The injected volume of the solution of polymer test specimen is 100 μl. The detector is a “WATERS 2410” differential refractometer and its associated chromatography data handling software is the “WATERS MILLENIUM” system. The calculated average molecular masses relate to a calibration curve produced using polystyrene standards.

The TPS elastomer may constitute all of the elastomer matrix or be predominant therein by weight (preferably representing over 50%, more preferably still over 70%) of the latter when this matrix contains one or more other elastomer(s), be they thermoplastic elastomers or not, for example of the diene type.

According to one preferred embodiment, the TPS elastomer is the only elastomer, and the only thermoplastic elastomer present in the self-sealing composition.

Extension Oil

The second essential ingredient in the self-sealing composition is an extension oil (or plasticising oil or extender oil), used at a very high proportion, of between 200 and 700 pce (namely between 200 and 700 parts by weight per hundred parts of elastomer).

It is possible to use any extension oil, preferably one that is slightly polar in nature, capable of extending and plasticising elastomers, notably thermoplastic elastomers.

At ambient temperature (23° C.), these oils, of varying viscosity, are liquid (remember that this means substances that have the ability ultimately to adopt the shape of their container) as opposed, in particular, to resins, particularly tackifying resins, which are solid by nature.

For preference, the extension oil is chosen from the group consisting of polyolefin oils (which means oils derived from the polymerisation of olefins, monoolefins or diolefins), paraffin oils, naphthene oils (of low or high viscosity), aromatic oils, mineral oils and blends of these oils.

More preferably still, the extension oil is chosen from the group consisting of polybutenes, paraffin oils and blends of these oils. Quite particular use is made of a polyisobutene oil, particularly polyisobutylene (PIB). By way of example, polyisobutylene oils are marketed particularly by Univar under the trade name “Dynapak Poly” (e.g. “Dynapak Poly 190”), by BASF under the trade names “Glissopal” (e.g. “Glissopal 1000”) or “Oppanol” (e.g. “Oppanol B12”); paraffin oils are marketed for example by Exxon under the trade name “Telura 618” or by Repsol under the trade name “Extensol 51”.

The number-average molecular weight (Mn) of the extension oil is preferably between 200 and 30000 g/mol, and more preferably still between 300 and 10000 g/mol. If the Mn is too low, there is a risk that the oil will migrate out of the self-sealing composition, whereas excessively high weights may cause excessive stiffening of this composition. A weight Mn of between 350 and 4000 g/mol, particularly of between 400 and 3000 g/mol, has proved to be an excellent compromise in the target applications.

The number-average molecular weight (Mn) of the extension oil is determined by SEC, the test specimen having previously been dissolved in tetrahydrofuran at a concentration of around 1 g/l; the solution is then filtered on a filter of porosity 0.45 μm before being injected. The equipment is the “WATERS alliance” chromatography apparatus. The elution solvent is tetrahydrofuran, the flow rate 1 ml/min, the temperature of the system 35° C., and the duration of the analysis 30 min. Use is made of a set of two WATERS columns with the trade name “STYRAGEL HT6E”. The injected volume of the solution of polymer test specimen is 100 μl. The detector is a “WATERS 2410” differential refractometer and its associated chromatography data handling software is the “WATERS MILLENIUM” system. The calculated average molecular masses relate to a calibration curve produced using polystyrene standards.

The person skilled in the art will know, from the description and exemplary embodiments that follow, how to adjust the quantity of extension oil according to the particular conditions of use of the self-sealing composition, and in particular, according to the item in which it is intended to be used.

It is preferable for the proportion of extension oil to be between 250 and 600 pce. Below the indicated minimum, there is a risk that the self-sealing composition will be too stiff for certain applications, whereas beyond the recommended maximum, there is a risk that the composition will exhibit insufficient cohesion. For this reason, the proportion of extension oil is more preferably still between 300 and 500 pce.

Various Additives

The two ingredients mentioned above, namely the TPS elastomer and the extension oil, are in themselves sufficient for the self-sealing composition to perform its valve function to the full, in respect of the items in which it is used.

However, various other additives may be added, typically in small amounts (preferably at proportions below 20 pce, more preferably still below 10 pce), these for example including reinforcing fillers such as carbon black, non-reinforcing or inert fillers, lamellar fillers, protective agents such as anti-UV, anti-oxidant or anti-ozone agents, various other stabilisers, and colorants that can advantageously be used to colour the self-sealing composition.

Although the self-sealing composition, thanks to its special formulation, does not require the use of any tackifying resin (remember that this means a resin capable of giving “tack” which means causing an immediate sticking effect when pressed lightly against a support), embodiments of the invention also may apply to instances in which such a tackifying resin is used, in which case and for preference in minority proportions, typically of less than 100 pce, and more preferably still of less than 50 pce (for example of between 0 and 20 pce.).

Aside from the elastomers (the TPS elastomers and any other elastomers there might be) already described, the self-sealing composition may also, again in a minority fraction by weight by comparison with the TPS elastomer, contain polymers other than elastomers, such as thermoplastic polymers compatible with the TPS elastomer for example.

The self-sealing material or composition described hereinabove is a compound that is solid (at 23° C.) and elastic, and is notably characterized, thanks to its special formulation, by very high flexibility and deformability.

According to one particular embodiment of the invention, particularly when used in a pneumatic tyre, the self-sealing composition has, for any temperature between +30° C. and +100° C., and preferably also between −30° C. and +30° C., a loss factor (tan δ) of below 0.2, more preferably of below 0.15, and a dynamic shear modulus G* lower than the service inflation pressure (denoted Pg) of the pneumatic item in question (particularly below 0.1 MPa), G* more preferably being somewhere between Pg/30 and Pg (particularly between 0.01 and 0.1 MPa), tan δ and G* being measured at a frequency of 10 Hz.

According to another particular embodiment of the invention, the self-sealing composition has an elongation at break greater than 500%, more preferably still greater than 800%, and a rupture stress higher than 0.2 MPa, these two parameters being measured at first elongation (i.e. without an accommodation cycle) at a temperature of 23° C., at a tensile test speed of 500 mm/min (in accordance with ASTM D412), and with respect to the initial cross section of the test specimen.

TPS elastomers such as SEPS or SEBS extended with high proportions of oils are well known and commercially available in extended form. By way of example, mention may be made of the products marketed by Vita Thermoplastic Elastomers or VTC (“VTC TPE group”) under the trade name “Dryflex” (e.g. “Dryflex 967100”) or “Mediprene” (e.g. “Mediprene 500 000M”), those sold by Multibase under the trade name “Multiflex” (e.g. “Multiflex G00”).

These products, which were notably developed for medical, pharmaceutical or cosmetic applications, can be worked in the way that is conventional for TPEs, by extrusion or moulding, for example starting out with a raw material available in the form of beads or granules.

Quite surprisingly, they have been found to be capable, possibly once their extension oil proportion has been adjusted if necessary to suit the range recommended by embodiments of the present invention (i.e. between 200 and 700 pce, preferably between 250 and 600 pce), of acting as a high-performance self-sealing composition.

For preference, that part of the valve that is made of the self-sealing material has an internal surface S1 intended to be under the pressure of the inflation air and an external surface S2 intended to be under the pressure of the ambient air, and the ratio S1/S2 is greater than or equal to 1, or even greater than or equal to 3, and preferably greater than or equal to 10.

Thus, by increasing the S1/S2 ratio, the tightness of the valve is improved. Specifically, by increasing the S1/S2 ratio, the compression of the self-sealing material is increased.

Optionally, the valve has an overall shape that exhibits symmetry of revolution about an axis normal to the internal surface S1 and the external surface S2.

For preference, with the two, internal S1 and external S2, surfaces separated by a minimum distance H and with D being the diameter of the surface S2 in a plane substantially perpendicular to the axis of revolution, H>D.

The ratio H/D, known as the slenderness ratio, is therefore higher than 1. The higher the slenderness ratio, the more the self-sealing material is compressed uniformly, thus improving the tightness of the valve.

As an alternative, the valve has an overall shape exhibiting axial symmetry, for example an elliptical, polygonal, etc., cross section. The overall shape of the valve will notably be chosen to allow the valve to be housed between the metal or textile threads of the plies of the tyre.

Advantageously, the valve includes means of attaching the valve to a support. The support may for example be a wheel rim. Such attachment means for example includes a groove moulded in the valve. Such attachment means allow the valve to be kept fixed with respect to the support. The pressure exerted by the inflation air on the internal surface is therefore transmitted to the self-sealing material which is thus compressed, in order to guarantee a good seal.

A subject of the invention also relates to a use of a self-sealing composition including at least, by way of predominant elastomer, a thermoplastic styrene elastomer and an extension oil in a proportion ranging between 200 and 700 parts by weight per hundred parts elastomer for manufacturing a valve for a tyre, for a rim or for an inner tube.

Another subject of the invention is a wheel element selected from a tyre, a rim, an inner tube, characterized in that the wheel element includes a valve as defined hereinabove.

Thanks to aspects of the invention, the wheel element need not be fitted with any mechanical valve.

In one embodiment, the valve is housed in a wall of the tyre or of the rim.

For preference, the valve forms part of an internal surface of the tyre or of the rim which surface is intended to be under the pressure of the inflating air, and part of an external surface of the tyre or of the rim which surface is intended to be under the pressure of the surrounding air.

For preference, the tyre includes means of identifying the valve, for example visible on an external surface of a sidewall of the tyre. The identifying means may include a mass of rubber of a colour or texture different from that of the rest of the tyre. This mass of rubber may extend over a given angular sector or alternatively may be axisymmetric.

In another embodiment, the tyre includes an in-built inner tube and a valve borne by an external surface of the in-built inner tube.

The built-in inner tube allows the tyre to have a built-in valve, reducing the interior noise generated during driving by the tyre. Moreover, it reduces the risks of air leaking between the rim and the beads of the tyre.

In yet another embodiment, the inner tube includes a closed cover that has an external surface bearing the valve.

### BRIEF DESCRIPTION OF THE DRAWINGS

The invention will be better understood from reading the following description, given solely by way of non-limiting example and with reference to the drawings in which:

FIG. 1 is a view in radial section of part of a tyre according to a first embodiment of the invention;

FIG. 2 is a view in section of a valve according to the embodiment of the invention of the tyre of FIG. 1;

FIG. 3 is a front-on view of one embodiment of the valve of FIG. 2;

FIG. 4 is a view similar to that of FIG. 1, of a tyre according to a second embodiment of the invention;

FIG. 5 is a view similar to that of FIG. 1, of a tyre according to a third embodiment of the invention;

FIG. 6 is a view similar to that of FIG. 1, of a tyre according to a fourth embodiment of the invention;

FIG. 7 is a view in section of a valve according to the embodiment of the invention of the tyre of FIG. 6;

FIG. 8 is a view similar to that of FIG. 1 of a tyre according to a fifth embodiment of the invention;

FIG. 9 is a view in radial section of the tyre of FIG. 8 in its green tyre state;

FIG. 10 is a schematic view of a mould used to manufacture the tyre of FIG. 8;

FIG. 11 is a view of a wheel rim according to a first embodiment of the invention;

FIGS. 12 and 13 are views of the wall of the rim and of the valve of FIG. 11 during intermediate steps in the method of producing the rim of FIG. 11;

FIGS. 14 and 15 are views similar to that of FIG. 11, of a rim according to second and third embodiments of the invention respectively;

FIG. 16 is a perspective view of an inner tube according to an embodiment of the invention; and

FIG. 17 is a schematic view of a mould used to manufacture an inner tube according to an embodiment of the invention.

Mutually orthogonal axes X, Y, Z corresponding to the customary radial (X), axial (Y) and circumferential (Z) orientations of a tyre have been depicted in the figures.

### DETAILED DESCRIPTION OF EMBODIMENTS OF THE INVENTION

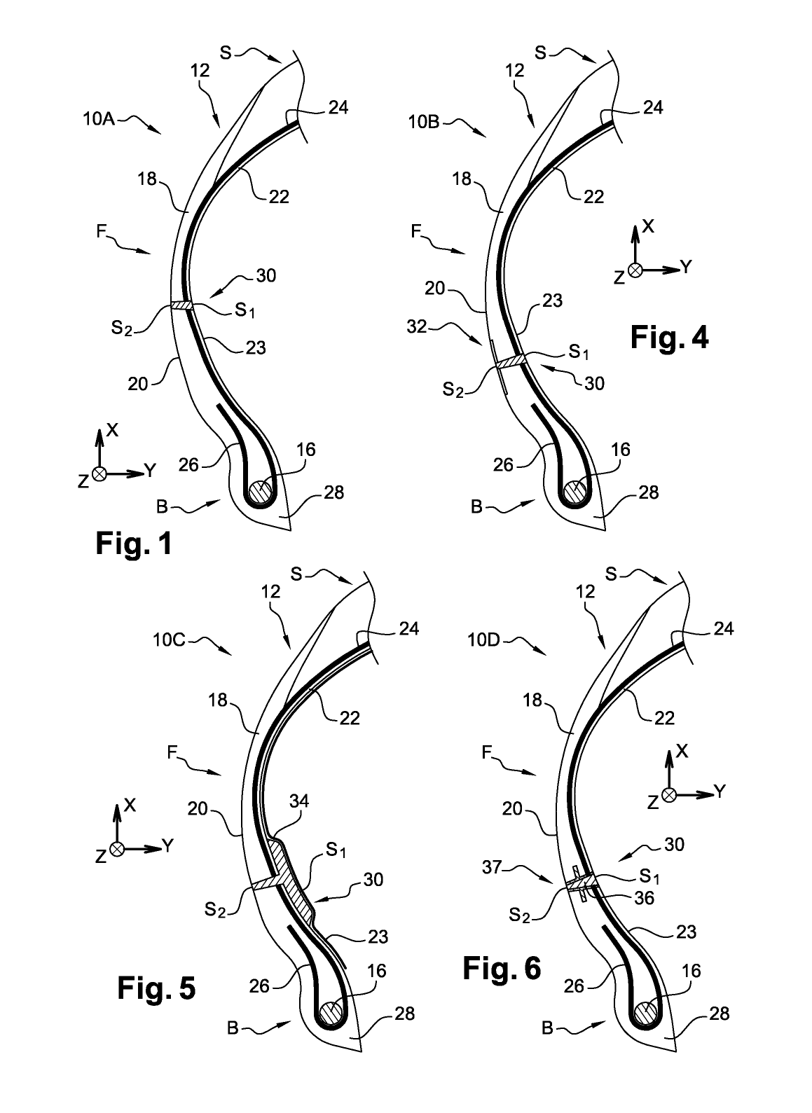

FIG. 1 depicts a tyre according to a first embodiment of the invention, denoted by the overall reference 10A. The tyre 10A is of the tubeless type, which means to say that it does not have an independent inner tube.

In the conventional way, the tyre 10A includes a cover 12 having a crown S extended by two sidewalls F and two beads B. Just one sidewall F and just one bead B are depicted in FIG. 1.

Two bead wires 16 (only one is depicted) are embedded in the beads B. The two bead wires 16 are arranged symmetrically with respect to a median radial plane of the tyre.

Each bead wire 16 exhibits symmetry of revolution about a reference axis. This reference axis, that runs substantially parallel to the direction Y, is more or less coincident with an axis of revolution of the tyre. The crown S includes a tread of conventional construction.

A mass of rubber 18 extends radially from the crown as far as the bead wire 16 of the bead B, thereby delimiting an external surface 20 of the sidewall F and of the bead B.

The tyre 10A also includes an inner sealing layer 22 delimiting an internal surface 23 and a carcass ply 24. In the bead B of the tyre 10A, the carcass ply 24 includes a part 26 that is turned back around the bead wire 16. The bead B also includes an annular mass of protective rubber 28 intended, in part, to secure the tyre 10A radially and axially on a wheel rim.

The tyre 10A includes a valve 30 housed in the sidewall F. The valve 30 forms part S1 of the internal surface of the tyre 10A which surface is intended to be under the pressure of the inflating air, and part S2 of the external surface 20 of the tyre 10A, which surface is intended to be under the pressure of the ambient air.

The valve 30 allows the tyre 10A to be inflated and deflated once this tyre has been mounted on a rim. The valve 30 includes, and in some cases may consist of, a self-sealing material containing at least one elastomer having a dynamic shear modulus G*, measured at 10 Hz, less than or equal to 0.06 MPa, preferably less than or equal to 0.03 MPa, and more preferably still, less than or equal to 0.01 MPa.

The tyre 10A is manufactured using the method described below. During this method, the uncured green form of a cover for the tyre 10A is cured and the self-sealing material intended to form the valve 30 is moulded. In this particular instance, because the self-sealing material has a softening temperature below or equal to the temperature at which the green tyre is vulcanised, the curing of the green form of the cover and the moulding of the material intended to form the valve 30 take place simultaneously. As an alternative, if the self-sealing material has a softening temperature higher than the temperature at which the green tyre is vulcanised, the material intended to form the valve 30 is moulded separately from the step of curing the green form of the cover.

The material intended to form the valve 30 includes, and in some cases may consist of, a composition containing at least, by way of predominant elastomer, a thermoplastic styrene elastomer and an extension oil in a proportion of between 200 and 700 parts by weight per hundred parts elastomer.

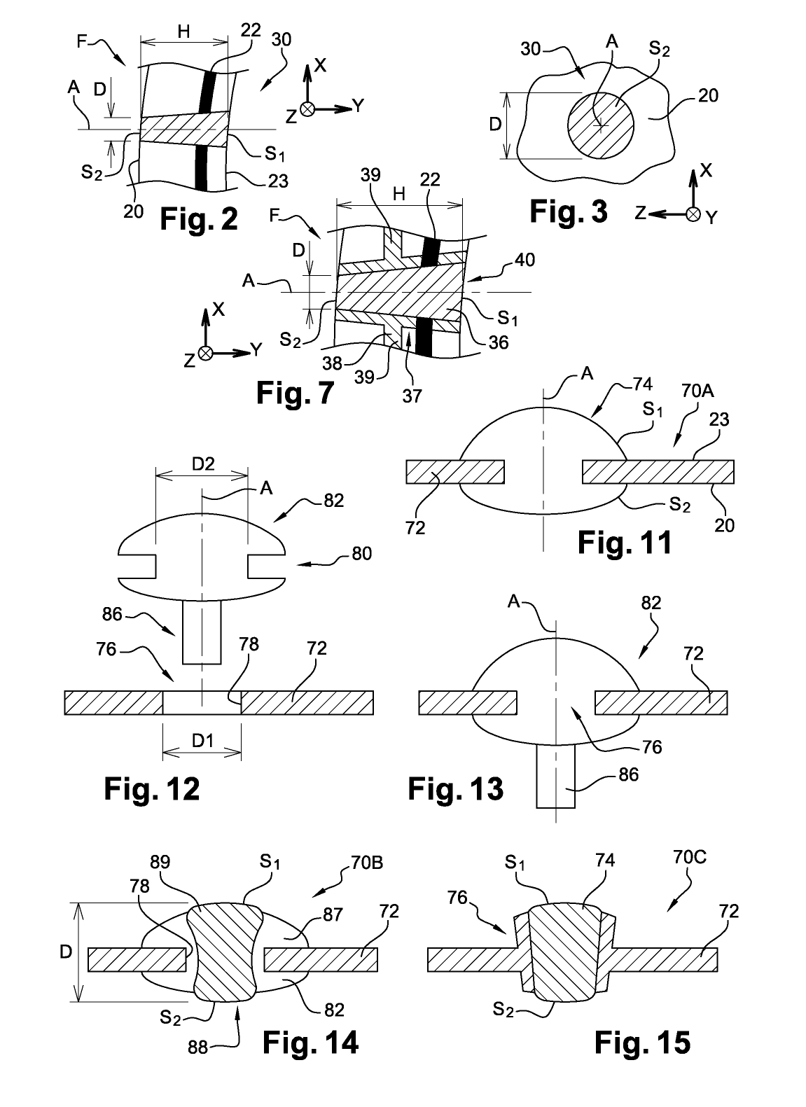

The valve 30 is depicted in FIGS. 2 and 3. The valve 30 is pre-slit. The valve 30 has an overall shape that exhibits symmetry of revolution about an axis A normal to the internal S1 and external S2 surfaces, and in this particular instance a conical overall shape, a cylindrical overall shape being an alternative. The two, internal S1 and external S2, surfaces are separated by a minimum distance H. The surfaces S1 and S2 have a shape that is cylindrical overall in the plane X, Z substantially perpendicular to the axis of revolution A. The surface S2 has a diameter D such that H>D. Furthermore, the ratio S1/S2 is greater than or equal to 1 and preferably greater than 3.

FIG. 4 depicts a tyre according to a second embodiment of the invention, denoted by the overall reference 10B. Elements that are analogous to those depicted in FIG. 1 are denoted by identical references.

Unlike the tyre according to the first embodiment, the tyre 10B includes means 32 of identifying the valve 30, which means are visible on the external surface 20 of the sidewall F of the tyre 10B.

FIG. 5 depicts a tyre according to a third embodiment of the invention, denoted by the overall reference 10C. Elements analogous to those depicted in the previous figures are denoted by identical references.

Unlike the tyre according to the second embodiment, the tyre 10C includes a layer 34 of rubber for protecting the valve 30, which may be made of the same material. The ratio S1/S2 can thus be greater than or equal to 10.

FIG. 6 depicts a tyre according to a fourth embodiment of the invention, denoted by the overall reference 10D. Elements analogous to those depicted in the previous figures are denoted by identical references.

Unlike the tyre according to the first embodiment, the valve 30 includes a mass 36 of the self-sealing material and a seating 37 for the mass 36. The seating 37 is made of rubber. As depicted in FIG. 7, the seating 37 includes a part 38 for attaching the seating 37 into the tyre 10D and including two branches 39 embedded in the rubber of the sidewall F. The seating 37 also includes a housing 40 for the mass 36, and with a flared overall shape such that the external section of the housing 40 is smaller than the internal section of the housing 40. Thus, the ratio S1/S2 is greater than or equal to 3.

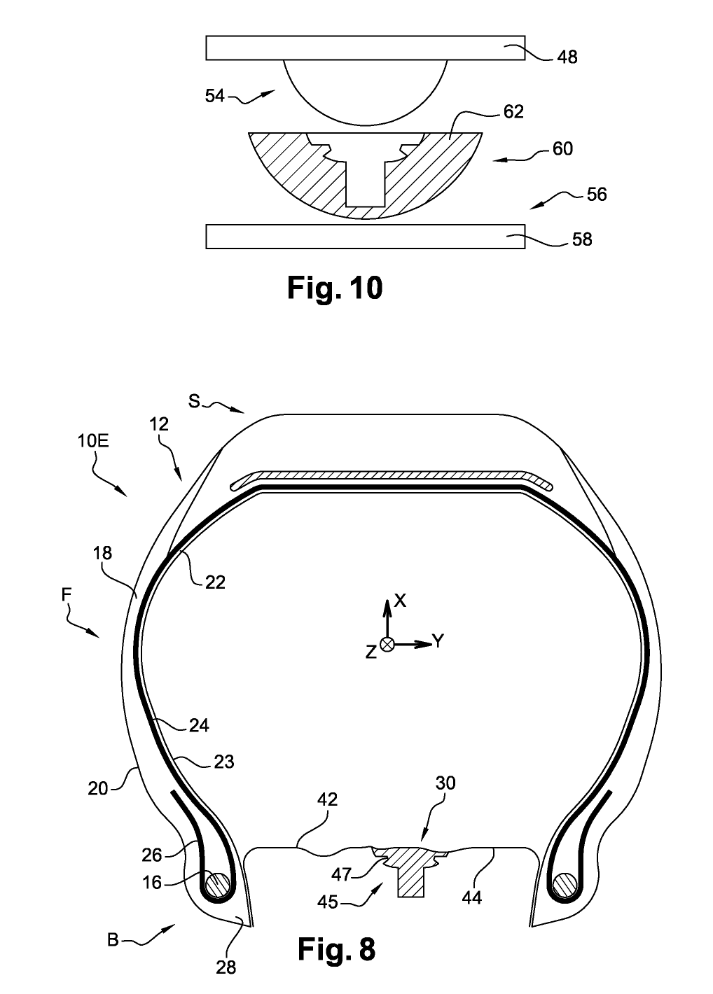

FIG. 8 depicts a tyre according to a fifth embodiment of the invention denoted by the overall reference 10E. Elements analogous to those depicted in the previous figures are denoted by identical references.

Unlike the tyres of the previous embodiments, the tyre 10E is of the type having a built-in inner tube. In addition to the cover 12, the tyre 10E includes an inner tube 42 fixed to the two beads B and extending between these. The internal volume of the tyre 10E is delimited by the inner sealing layer 22 and the built-in inner tube. The sealing layer 22 and the inner tube 42 are made of butyl.

The tyre 10E also includes a valve 30 borne by an external surface 44 of the built-in inner tube 42. The valve 30 is made of a self-sealing material including at least one elastomer that has a dynamic shear modulus G*, measured at 10 Hz, less than or equal to 0.06 MPa, preferably less than or equal to 0.03 MPa, and more preferably still, less than or equal to 0.01 MPa.

The valve 30 of the tyre 10E includes means 45 of attaching the valve to a support, in this instance to a wall of a rim with a valve passage orifice (not depicted). The attachment means 45 includes an attachment groove 47 moulded into the self-sealing material.

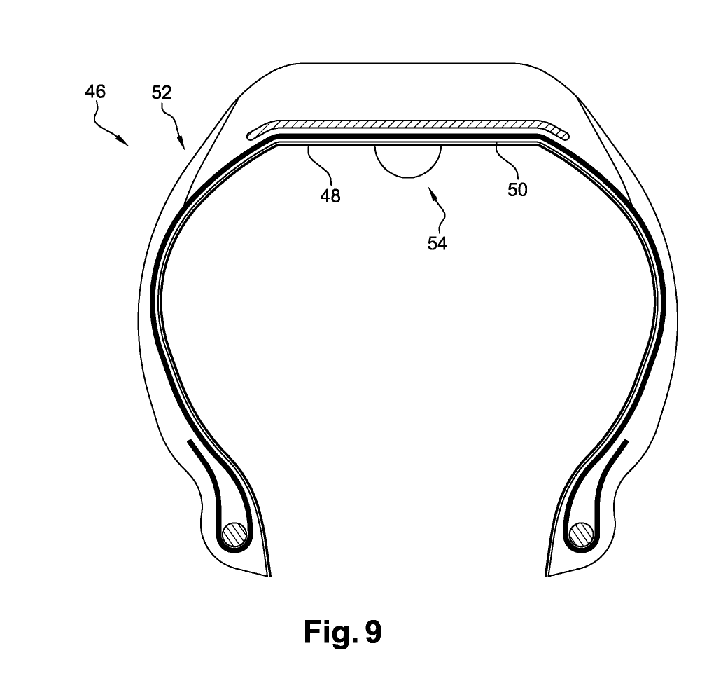

FIG. 9 depicts an uncured green form 46 of the tyre 10E. The green tyre 46 includes masses of uncured rubber which, once cured, will give rise to the aforementioned masses of rubber. The green tyre 46 includes a layer of uncured rubber 48 intended to form the inner tube 42 and a non-stick layer 50 interposed between a green form 52 of the cover 12 of the tyre 10E and the layer 48.

The green form 46 also includes a mass 54 of the self-sealing material intended to form the valve 30 borne by the layer 48. The mass 54 of self-sealing material includes, and in some cases may consist of, a composition containing at least, by way of predominant elastomer, a thermoplastic styrene elastomer and an extension oil in a proportion of between 200 and 700 parts by weight per hundred parts elastomer.

FIG. 10 depicts a mould 56 for manufacturing the tyre 10E. The mould 56 includes a flexible curing membrane and a member 60 for moulding the valve 30. The member 60 includes a flexible mould 62 interposed between the flexible membrane 58 and the mass 54 of self-sealing material.

FIG. 11 depicts a wheel rim according to a first embodiment of the invention and denoted by the overall reference 70A.

The rim 70A includes a wall 72 and a valve 74. The valve 74 is pre-slit. The rim 70A includes an orifice 76 housing the valve 74 made in the wall 72. The valve has an overall shape that exhibits symmetry of revolution about an axis A. The valve 74 forms part S1 of an internal surface 23 of the rim that is intended to be under the pressure of the inflation air and part S2 of an external surface 20 of the rim that is intended to be under the pressure of the ambient air T. The valve 74 is made of a self-sealing material including at least one elastomer that has a dynamic shear modulus G*, measured at 10 Hz, less than or equal to 0.06 MPa, preferably less than or equal to 0.03 MPa, and more preferably still, less than or equal to 0.01 MPa.

The orifice 76 allows fluidic communication between the two sides of the wall 72 when the valve 74 is absent. The orifice 76 is of circular overall shape with diameter D1 and is delimited by an edge 78 of the wall 72. The valve 74 includes a groove 80 for attaching the valve 74 to the edge 78 of the wall 72.

The groove 80 has a circular overall shape of diameter D2>D1 when the valve 74 is not fitted in the wall 72, as can be seen in FIG. 12 which depicts the wall 72 and a precursor 82 of the valve 74 not fitted in the wall 72. Thus, when the valve 74 is fitted in to the orifice 76, the valve 74 is compressed so as to improve the sealing of the rim according to an embodiment of the invention.

The valve 74 made of the self-sealing material has an internal surface S1 intended to be under the pressure of the inflation air and an external surface S2 intended to be under the pressure of the ambient air. The ratio S1/S2 is greater than or equal to 1. As an alternative, the ratio S1/S2 is greater than or equal to 3, preferably greater than or equal to 10.

The valve 74 is manufactured using the method described below. During this method, the self-sealing material intended to form the valve 74 is moulded in a mould. The self-sealing material includes, and in some cases may consist of, a composition including at least, by way of predominant elastomer, a thermoplastic styrene elastomer and an extension oil in a proportion of between 200 and 700 parts by weight per hundred parts elastomer. The precursor 82 depicted in FIG. 12 is thus obtained. The precursor 82 includes a part 86 for holding the valve. This part 86 makes it easier for the groove 80 to be positioned by hand in the orifice 76. The precursor 82 is positioned in the orifice 76. This then yields the precursor 82 assembled into the orifice 76 as depicted in FIG. 13. The part 86 of the precursor 82 is then removed, for example by cutting it off, in order to obtain the rim according to an embodiment of the invention as depicted in FIG. 11.

FIG. 14 depicts a rim according to a second embodiment of the invention, and denoted by the overall reference 70B. Elements analogous to these depicted in the preceding figure are denoted by identical references.

Unlike the rim according to the first embodiment, the valve 74 includes a part 87 for attaching the valve 74 to the edge 78 of the wall 72. The part 87 has an overall shape exhibiting symmetry of revolution delimiting a central housing 88. The valve 74 also includes a mass 89 of the self-sealing material.

The part 87 contains rubber. The part 87 protects the mass 89 from the edge 78. The mass 89 is made up of a mass of self-sealing material containing at least one elastomer having a dynamic shear modulus G*, measured at 10 Hz, less than or equal to 0.06 MPa, preferably less than or equal to 0.03 MPa, and more preferably still, less than or equal to 0.01 MPa.

The mass 89 of the valve 74 made of the self-sealing material has an internal surface S1 intended to be under the pressure of the inflating air and an external surface S2 intended to be under the pressure of the ambient air. The ratio S1/S2 is greater than or equal to 1. As an alternative, the ratio S1/S2 is greater than or equal to 3, and preferably greater than or equal to 10.

FIG. 15 depicts a rim according to a third embodiment of the invention, denoted by the overall reference 70C. Elements analogous to those depicted in the previous figure are denoted by identical references.

Unlike the rim 70A according to the first embodiment, the rim 70C according to the third embodiment includes a valve 74 made of the self-sealing material and a seating 76 for the valve 74. The seating 76 is formed in the wall 72. The seating 76 has a flared overall shape so that the external section of the seating 76 is smaller than the internal section of the seating 76. Thus, the ratio S1/S2 is greater than or equal to 1, or even 3, and preferably 10.

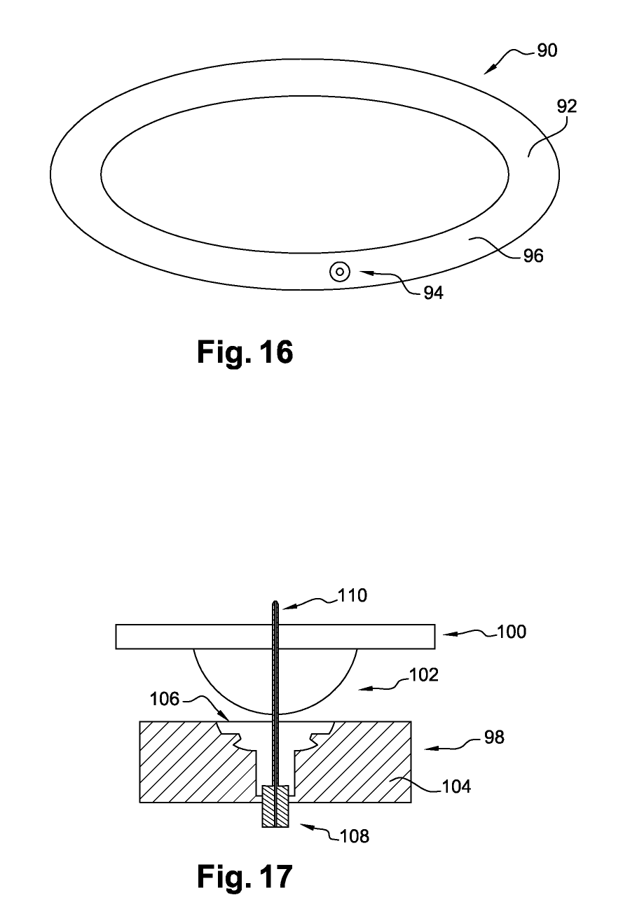

FIG. 16 depicts an inner tube according to an embodiment of the invention, denoted by the overall reference 90.

The inner tube 90 includes a closed toroidal cover 92 and a valve 94 borne by an external surface 96 of the cover 92. The valve 94 is made of a self-sealing material containing at least one elastomer having a dynamic shear modulus G*, measured at 10 Hz, less than or equal to 0.06 MPa, preferably less than or equal to 0.03 MPa, and more preferably still, less than or equal to 0.01 MPa.

Further, the valve 94 of the inner tube 90 includes means of attaching the valve to a support, in this instance to a wall of a rim containing a passage orifice for the valve 94 (the orifice is not depicted), all similar to those of the valve 30 of the tyre 10E.

FIG. 17 depicts a mould 98 for manufacturing the inner tube 90. FIG. 16 also depicts a green form 100 of the cover 92, the inner tube 90 intended to form the cover 92 and a mass of a self-sealing material 102 which is intended to form the valve 94. The mass of self-sealing material 102 includes, and in some cases may consist of, a composition including at least, by way of predominant elastomer, a thermoplastic styrene elastomer and an extension oil in a proportion of between 200 and 700 parts by weight per hundred parts elastomer.

The mould 98 includes a wall 104 for moulding the external surface 96 of the cover 92 in which external surface is formed a cavity 106 for moulding the valve 94. The mould 98 also includes means 108 for pressurising the green form 100 when the cover 92 is being cured. The means 108 includes an air compressor (not depicted) and a needle 110.

The key stages of a method of manufacturing the inner tube 90 will now be described and in this method, because the self-sealing material 102 has a softening temperature lower than or equal to the temperature at which the green form 100 is vulcanised, the green form 100 is cured and the mass of self-sealing material 102 is moulded both at the same time. While the green form 100 is being cured and the mass 102 is being moulded in the mould 98, the green form 100 is kept under pressure by injecting air from the compressor into the green form 100 using the needle 110 which passes through the valve 94 and the green form 100. After curing, the inner tube 90 is demoulded and the needle 110 is withdrawn from the inner tube 90. The nature of the material 102 allows the orifice generated by the presence of the needle 110 during the curing to close back up with pressure exerted on the valve 94.

In an alternative form of the method of manufacturing the inner tube 90, when the self-sealing material 102 has a softening temperature higher than the temperature at which the green form 100 is vulcanised, the green form 100 is cured and the mass 102 is moulded in separate operations. During the curing of the green form 100, the green form 100 is kept under pressure by injecting air from the compressor into the green form 100 via the needle 110 which passes through the green form 100. Once the cover 92 has been cured, the valve 94, which has been moulded separately elsewhere, is attached, for example by bonding.

The invention is not restricted to the embodiments described hereinabove.

Specifically, whatever the wheel element with which the valve is associated, the valve can be arranged so that that part of the valve that is made of the self-sealing material has an internal surface S1 intended to be under the pressure of the inflating air and an external surface S2 intended to be under the pressure of the surrounding air and so that the ratio S1/S2 is greater than or equal to 1, or even greater than or equal to 3, and preferably greater than or equal to 10.

Furthermore, whatever the wheel element with which the valve is associated, the valve may or may not be pre-slit.

1. A self-sealing valve formed of, at least in part, a self-sealing material that includes at least one elastomer that has a dynamic shear modulus G*, measured at 10 Hz, less than or equal to 0.06 MPa, wherein the valve may be used for a tyre, for a wheel rim, or for an inner tube.

2. A self-sealing valve according to claim 1, wherein the dynamic shear modulus is less than or equal to 0.03 MPa.

3. A self-sealing valve according to claim 1, wherein the dynamic shear modulus is less than or equal to 0.01 MPa.

4. The valve according to claim 1, wherein the valve is pre-slit.

5. The valve according to claim 1, wherein the valve is made entirely of the self-sealing material.

6. The valve according to claim 1, wherein the self-sealing material includes a thermoplastic styrene elastomer and an extension oil in a proportion of between 200 and 700 parts by weight per hundred parts elastomer.

7. The valve according to claim 1, wherein a part of the valve that is made of the self-sealing material has an internal surface S1 intended to be pressurized by inflation air and an external surface S2 intended to be pressurized by ambient air, and a ratio S1/S2 is greater than or equal to 1.

8. The valve according to claim 1, wherein a part of the valve that is made of the self-sealing material has an internal surface S1 intended to be pressurized by inflation air and an external surface S2 intended to be pressurized by ambient air, and a ratio S1/S2 is greater than or equal to 3.

9. The valve according to claim 1, wherein a part of the valve that is made of the self-sealing material has an internal surface S1 intended to be pressurized by inflation air and an external surface S2 intended to be pressurized by ambient air, and a ratio S1/S2 is greater than or equal to 10.

10. The valve according to claim 7, wherein the valve has an overall shape that exhibits symmetry of revolution about an axis (A) normal to the internal surface S1 and the external surface S2.

11. The valve according to claim 10, wherein the internal S1 and external S2 surfaces are separated by a minimum distance H, and wherein a diameter D of the external surface S2 in a plane substantially perpendicular to the axis (A) such that H>D.

12. The valve according to claim 1, comprising means for attaching the valve to a support.

13. A composition comprising:
a thermoplastic styrene elastomer; and
an extension oil in a proportion ranging between 200 and 700 parts by weight per hundred parts elastomer,
wherein the composition is used for manufacturing a valve for a tyre, a wheel rim, or an inner tube.

14. A valve according to claim 1, wherein the valve is incorporated in a wheel element selected from a tyre, a wheel rim, and an inner tube.

15. A valve according to claim 14, wherein the wheel element is a tyre or a wheel rim, and the valve is housed in a wall of the tyre or the rim.

16. A valve according to claim 15, wherein the valve forms part of an internal surface S1 of the tyre or the rim, the internal surface S1 being intended to be pressurized with inflating air, and wherein the valve forms part of an external surface S2 of the tyre or the rim, the external surface S2 being intended to be pressurized with surrounding air.

17. A valve according to claim 14, wherein the wheel element is a tyre that includes an in-built inner tube, and wherein the valve is borne by an external surface of the in-built inner tube.

18. A valve according to claim 14, wherein the wheel element is an inner type with a closed cover that has an external surface bearing the valve.
